(19) United States
(12) Patent Application Publication
(10) Pub. No.: US 2017/0091905 A1
(43) Pub. Date: Mar. 30, 2017

(54) Information Handling System Defocus Tracking Video

(71) Applicant: Dell Products L.P., Round Rock, TX (US)

(72) Inventors: Todd F. Basche, Los Altos, CA (US); Steven P. Zessin, Austin, TX (US)

(73) Assignee: Dell Products L.P., Round Rock, TX (US)

(21) Appl. No.: 14/863,506

(22) Filed: Sep. 24, 2015

(51) Int. Cl. G06T 5/00; H04N 5/232; G06F 3/0482; G06T 1/20; G06F 3/0484

(52) U.S. Cl. CPC G06T 5/002; G06T 1/20; G06F 3/04842; G06F 3/0482; H04N 5/23229; G06T 2207/10016; G06T 2207/10024

(57) ABSTRACT

A portable information handling system presents visual images with defocus adjustments by defining one or more objects based on image blur at the object edges. The defined object is tracked based upon the object edges and the visual image outside the area of the defined object is adjusted to have a defocus that emphasizes the presentation of the defined object. In addition, the defined object provides a basis for other adjustments, such as color presented in association with the object or metadata that presents additional information with the defined object.

### BACKGROUND OF THE INVENTION

Field of the Invention

The present invention relates in general to the field of information handling system image capture, and more particularly to an information handling defocus tracking video.

Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Portable information handling systems are built into portable housings with integrated input/output (I/O) devices, such as a touchscreen liquid crystal display (LCD). In particular, tablet and smartphone portable information handling systems are built into planar housings with a display presenting information as visual images at one side of the planar housing. End users have migrated towards the relatively small planar housings used by smartphones to provide a convenient handheld mobile device for basic processing functions, such as web surfing and reading emails. In addition to providing convenient processing capability, portable information handling systems have taken over a number of information processing functions that were often handled by other devices. Most prominently, portable information handling systems have taken over the role of mobile telephones by providing end users with a handset to place telephone calls. Web browsing and email are supported through the wireless telephone provider's network. Portable information handling systems often include GPS receivers and access to maps to replace handheld navigation devices. Another common feature for portable information handling systems is an integrated camera to take digital pictures and videos.

The relatively small size of smartphone and tablet devices has made the cameras in these devices popular with end users. As digital light sensors have improved, the images captured by the cameras have improved in quality. Typically, camera resolution is discussed in terms of the number of megapixels captured with each image. A greater number of megapixels means a greater number of light data points used to recreate a captured image. However, measuring camera quality just based upon sensor pixel size is misleading. Even the best camera sensor will take a low quality picture if light for the sensor is captured by a poor lens. Since smartphones and tablets are built with thinness as a goal, manufacturers have some difficulty assembling quality lens into the systems. Generally, as a result, the quality of portable information handling system pictures and videos tends to suffer. End users generally understand the limitations of portable information handling system cameras and accept that lower quality as a tradeoff for convenience.

One solution for lower quality images captured by portable information handling systems is post processing of the images to remove or correct data that tends to have lower quality. For example, videos from portable information handling systems tend to shake because end users have difficulty holding the system still while information is captured. Stabilization software or firmware attempts to correct poor video quality by massaging pixels into the location that would have resulted if the camera was held still. Other post processing techniques aid in correcting contrast, brightness and blurriness by replacing pixel values captured by a camera with pixel values that represent what likely should have been captured. Although post processing can provide improved image quality, the steps needed to accomplish post processing tend to add complexity that often outweighs the benefits to end users. Generally, if an end user desires high quality images, the end user resorts to dedicated camera systems that offer greater user control over lens functions, such as longer focal length and focus control.

### SUMMARY OF THE INVENTION

Therefore, a need has arisen for a system and method which provide an information handling system having simplified post-processing of images captured by a camera.

In accordance with the present invention, a system and method are provided which substantially reduce the disadvantages and problems associated with previous methods and systems for capturing images with an information handling system. Defined objects detected in an image by focus blur at the object edge are applied for post processing of the image with focus blurring outside the defined object to create viewing effects that highlight visual image elements as desired by an end user.

More specifically, a portable information handling system processes information with a processor that executes instructions stored in memory to present information as visual images at a display, such as with processing performed by a graphics processing unit (GPU). A focus mapper analyzes images presented by the graphics processor to detect defined objects in the image based upon blur that accompanies the transition from focus of the object and its surrounding. The focus mapper tracks defined objects selected by an end user by analyzing the image blur so that a focused image adjuster adjusts presentation of the image outside the selected defined objects, such as by blurring the those portions to add a defocused appearance. Other types of adjustments include changing the color of the defocused appearance, such as by applying black and white coloring, adding meta data to the selected defined areas for presentation at the image, and defining an active area in the display that prioritizes one or more defined objects as the focused object in the visual image while defocusing other defined objects.

The present invention provides a number of important technical advantages. One example of an important technical advantage is that a visual image has an adjusted appearance based upon selected defined objects identified with blurring along the object edges. Defocus of a visual image outside of the selected defined object edges provides a visual presentation that highlights the defined object. Additional impactful visual effects are provided by applying adjustments to the visual image based upon the selected defined object. For example, metadata associated with defined objects provides presentation of user-defined information in association with a defined object. As another example, defined objects may be further highlighted with alternative visual effects within and outside of the defined object, such as by applying black and white color effects outside of a defined area. Where multiple defined objects are highlighted, priority definitions may be applied to select one defined object for highlighting relative to another, such as based upon the portion of the visual image in which the defined object is presented. End users are provided with an automated tool that enhances presentation of desired portions of visual images that are taken by cameras with otherwise limited image capture quality.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of a portable information handling system positioned to capture an image;

FIG. 2 depicts a block diagram of a portable information handling system configured to post process captured images based upon image focus;

FIG. 3 depicts a display presenting a visual image with defined objects identified for an end user to select for post processing;

FIG. 4 depicts a flow diagram of a process for selecting a defined object in a visual image for post processing;

FIGS. 5A and 5B depict an example of a visual image before and after post processing relative to a defined object;

FIGS. 6A and 6B depict an example of a visual image with a defined object having an active area;

FIG. 7 depicts an example of a visual image having an area outside of a defined object adjusted to assume a black and white coloring;

FIGS. 8A, 8B and 8C depict a defined object with a focus map defined by image brightness;

FIG. 9 depicts an example of a visual image having meta data associated with the defined object; and

FIG. 10 depicts a block diagram of an acceleration based correction of a visual image.

### DETAILED DESCRIPTION

Post processing of visual information at a portable information handling system highlights defined objects tracked with defocus mapping. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

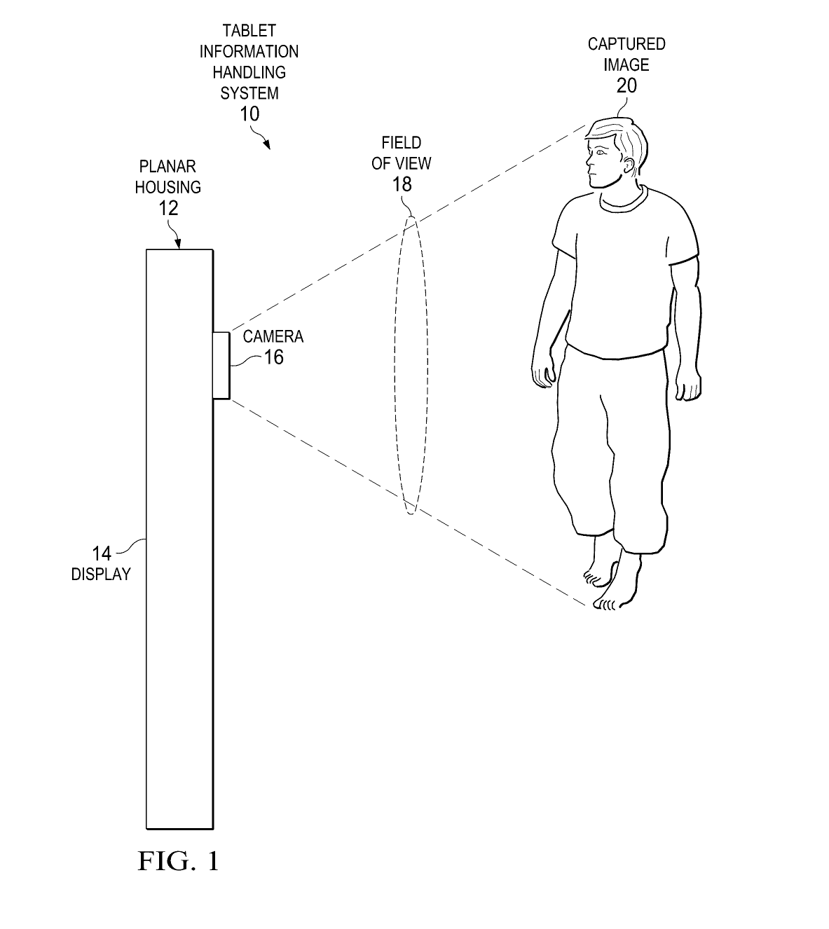

Referring now to FIG. 1, a block diagram depicts a portable information handling system 10 positioned to capture an image. Portable information handling system 10 has a planar housing 12 with a display 14 disposed on one side to present visual images and a camera 16 disposed on an opposing side to capture images. For example, tablet information handling systems and/or smartphones typically have configurations similar to that depicted by FIG. 1. Camera 16 has a field of view 18 aligned to capture an image of a target 20. End users typically view the target 20 in display 14 before, during and after the capture of the image so that the end user knows what image is captured. In addition, end users often view images from storage after capture by selecting the images from a library and presenting the images at display 14. Images include still images, such as in JPG compressed form, and videos, such as in MP4 form.

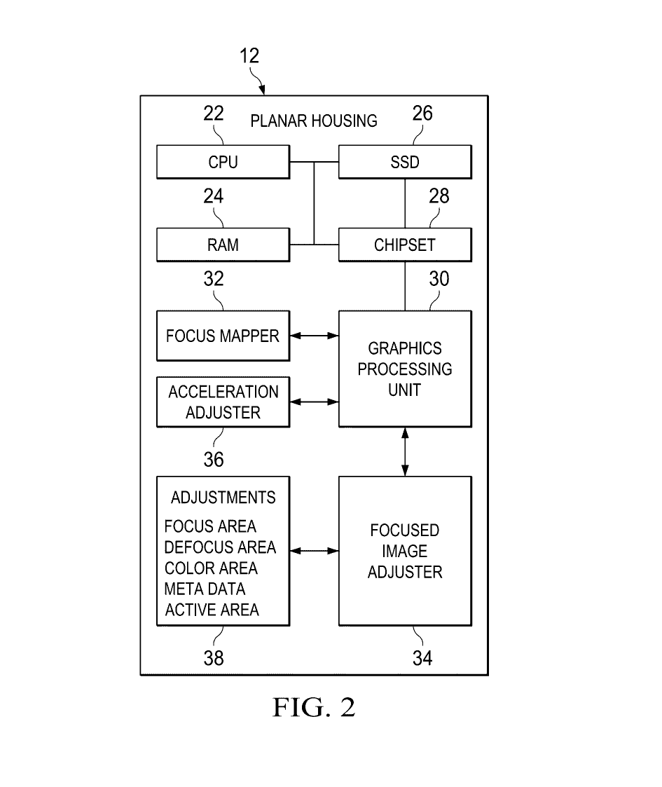

Referring now to FIG. 2, a block diagram depicts a portable information handling system 10 configured to post process captured images based upon image focus. Portable information handling system 10 may be built into a planar housing, such as with a tablet or smartphone configuration, or may use other types of portable housing configurations, such as those that support handheld usage to allow capture of images. Portable information handling system 10 includes a central processing unit (CPU) 22 that executes instructions stored in memory, such as random access memory (RAM) 24 and a solid state drive (SSD) 26. For example, portable information handling system 10 runs an operating system, such as Windows or Android, that supports execution of applications, such as for viewing and accessing images captured by a camera. A chipset 28 includes processing components and firmware instructions that manages interactions between physical components to process information, such as memory, networking resources and graphics resources. For example, a graphics processing unit (GPU) 30 included in or communicating with chipset 28 accepts visual information from CPU 22 and processes the visual information to generate pixel values for presentation of visual images at display 14.

In order to highlight defined objects selected by an end user, portable information handling system 10 includes a focus mapper 32 and focused image adjuster 34 that cooperate to post process visual information with defocusing of non-highlighted areas. Focus mapper 32 and focus adjuster 34 are, for example, firmware and/or software instructions executing on GPU 30, CPU 22 and/or other processing components to adjust visual information for presentation at display 14. Visual information may be adjusted in real time as captured by a camera or may be adjusted after capture and storage in memory. A user chooses a scene from a displayed image, such as a display still image or video, selects an area or element that is identifiable by focus mapper 32 as a defined object, and then focused image adjuster 34 defocuses or blurs the original image data or video frame, with additional visual information similarly processed through the remainder of video frames that include the identifiable object. Focus mapper 34 tracks defined objects using a focus map of each individual image or frame in visual information and applies defocus to the visual image outside of the defined objects selected for focus by an end user.

Focus mapper 34 identifies and tracks defined objects by leveraging a selected of known models of defocus theory, such as active illumination, coded aperture, inverse diffusion and interpolation theories. Generally, the defined object or defined objects are identified and tracked by analyzing an image or video frame within a video with a mixture of focused and defocused objects, detecting the edges of focused object(s) to estimate a focus map based on edge blurriness, which is depicted explicitly by each defocus theory. Individual image frames of a video have a focus map related over time with similar defocus regions and shapes that track from the selected images of an original video frame so that defocus is applied across multiple frames over time. Focused image adjuster 34 adds blurring to the visual information outside of the defined objects as tracked by focus mapper 32 over time. In addition, as set forth in greater detail below, focused image adjuster 34 may apply other types of adjustments with or in the place of defocus adjustment. For example, a user may select from adjustments 38 based on a focused area, a defocused area, a color area, meta data associated with an area and an active area defined in the display. An acceleration adjuster 36 cooperates with focus mapper 32 to correct image impacts from large accelerations at information handling system 20 as set forth in greater detail in FIG. 10 below.

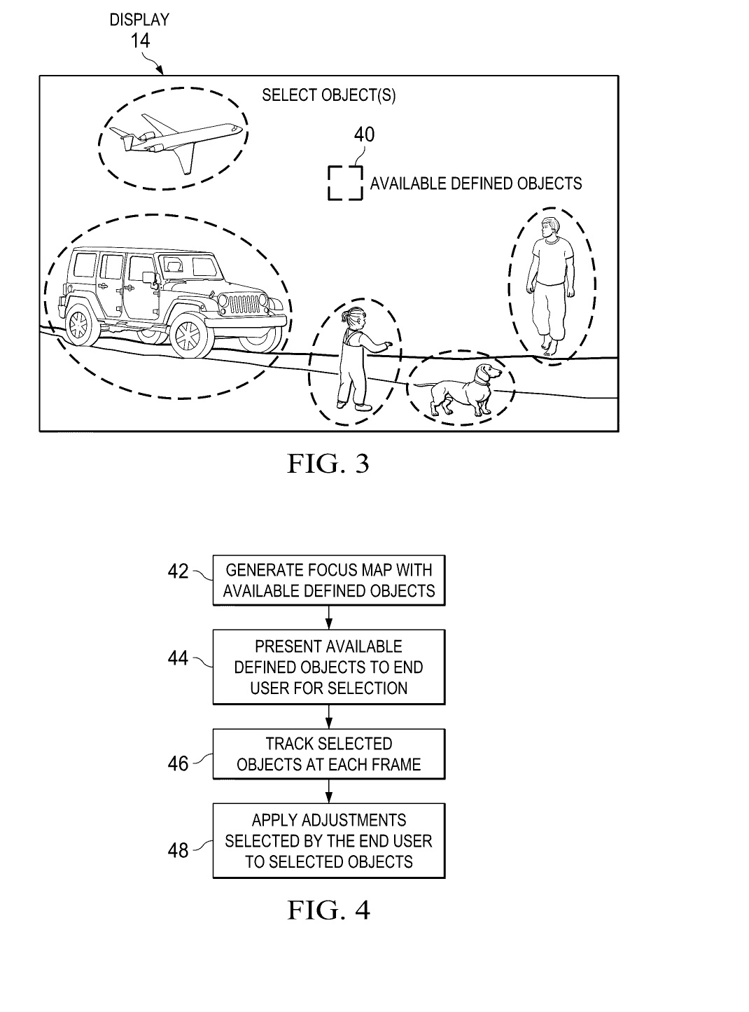

Referring now to FIG. 3, a display 14 is depicted presenting a visual image with defined objects 40 identified for an end user to select for post processing. For example, the end user initiates a selection mode with a still image, such as a video frame, so that focus mapper 32 has time to perform an in depth analysis of the visual image to highlight available defined objects for selection by the end user. An end user selects a defined object by tapping on a highlighted area of display 14 so that focus mapper 32 tracks the defined area in subsequent frames by reference to the edges of the defined area. In some embodiments that have adequate processing capability, multiple defined objects 40 are tracked at the same time.

Referring now to FIG. 4, a flow diagram depicts a process for selecting a defined object in a visual image for post processing. The process starts at step 42 with generation of focus map having defined objects that are available for tracking. At step 44, the available defined objects are presented to an end user for selection of one or more defined objects to track and perform post processing. At step 46, an end user selects one or more of the defined objects from the available defined objects for tracking in subsequent frames. At step 48, visual adjustments selected by the end user are applied at each frame based upon the selected defined objects so that the visual information is adjusted as desired by the end user.

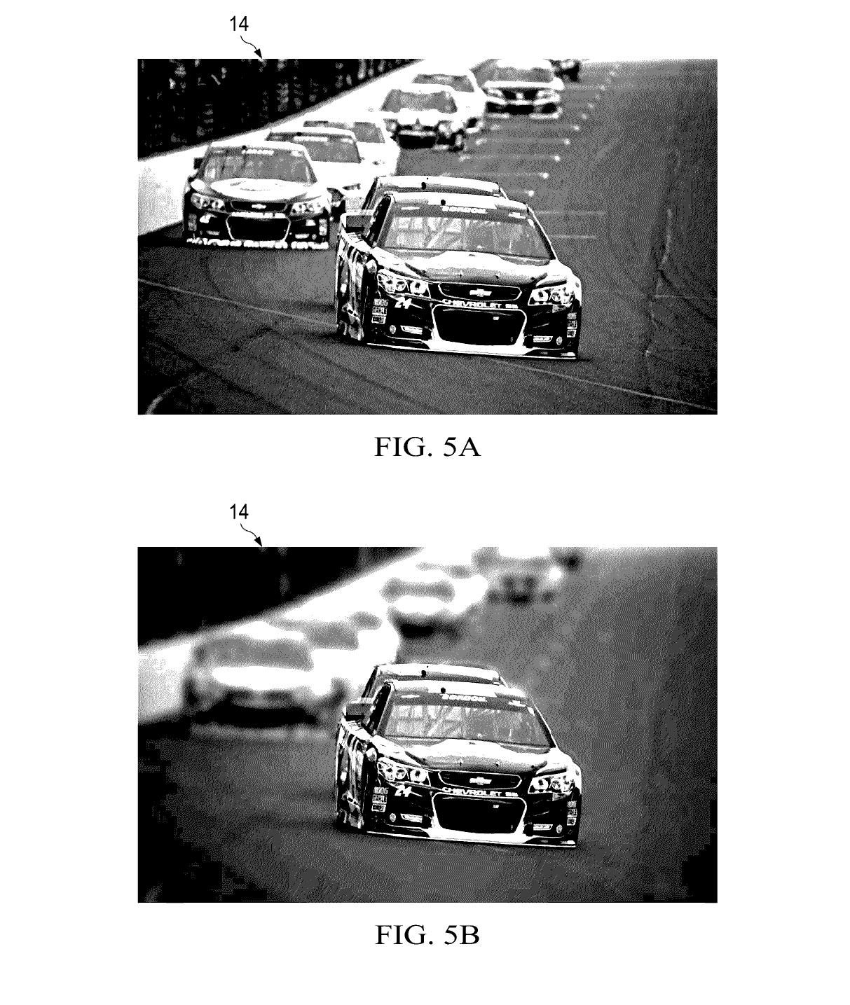

Referring now to FIGS. 5A and 5B, an example is depicted of a visual image before and after post processing relative to a defined object. In an original frame example shown by FIG. 5A, a visual image captures a line of cars, each of which has definable edges for defocus tracking. An end user has selected the lead car for defocus tracking so that post processing of the image as shown in FIG. 5B highlights the lead care with blurring adjustment added to each of the following cars. The focus map in the example of FIGS. 5A and 5B has a shape determined from pixel coordinates associated with the blurred focus around the outer edges of the lead car. Once these coordinates are identified, focus mapper 32 tracks the similar edges from frame to frame in the video visual information. For example, a typical smartphone or tablet device will capture 15 to 60 frames per second so that a relatively small motion takes place from frame to frame for each defined object. Focused image adjuster 34 in the example embodiment helps to highlight the lead car as a defined object by applying a defocus or blurring to the visual image outside of the lead car. Once the defined object is highlighted and tracked, subsequent frames are adjusted in a similar manner. An end user may selected stored visual information for the post processing treatment, or may select a live video feed from a camera to perform post processing in real time as images are captured.

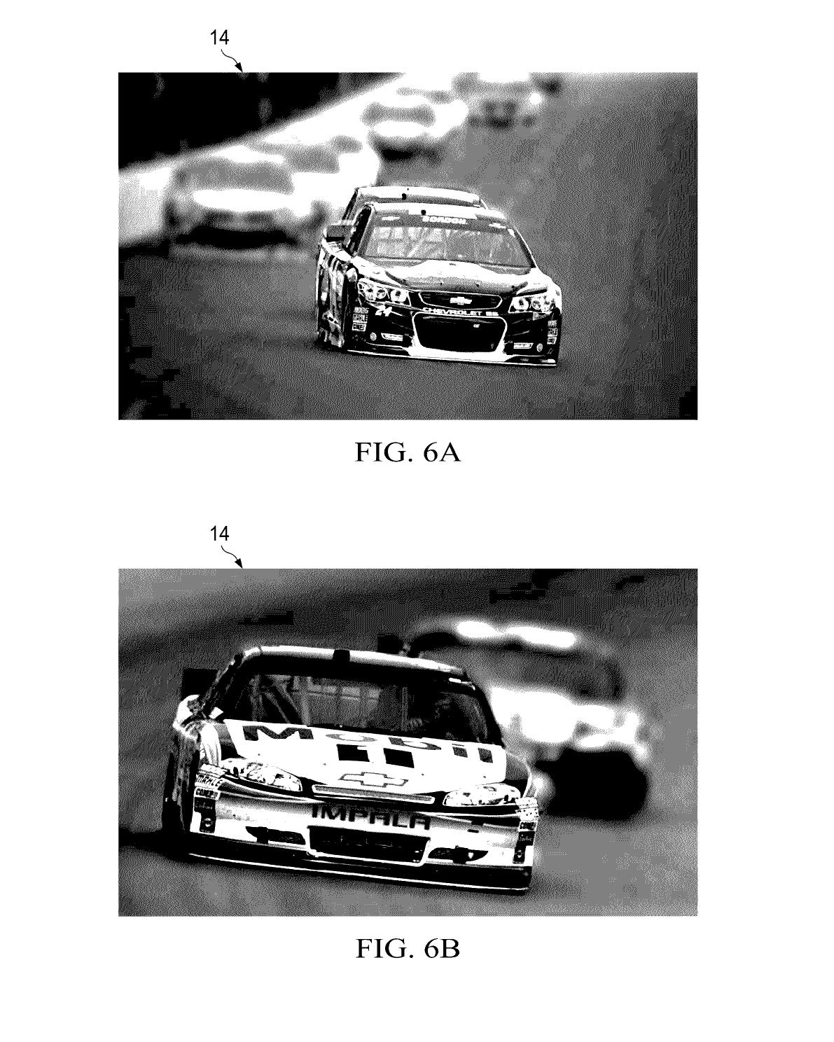

Referring now to FIGS. 6A and 6B, an example is depicted of a visual image with a defined object having an active area. In FIG. 6A, a lead car is selected as a defined object so that it is highlighted. In addition, the end user defines an active area in the central region of the visual image so that defined objects in the active area are highlighted while defined objects that fall out the active are lose their highlighting. The active area predicts when a new defined object has come into focus as the primary object of interest to the end user to allow a dynamic transition of defocus from the lead car shown in FIG. 6A to the new lead care in FIG. 6B. In one embodiment, the selection of one defined object for highlighting at a time is made based upon the amount of an active area that each of plural defined objects has. For example, an end user selects multiple defined objects and an active area for tracking by focus mapper 32, such as by associating metadata with each defined object. In one embodiment, focus mapper 32 compares metadata of a current image with a previous image to generate a delta from the differences between the two images. Focus mapper 32 identifies the main elements in the compared frames and determines a direction of motion of defined objects being tracked from the previous to the current frame. A transition from focus on a first defined object to a second defined object may be initiated based upon a variety of factors determined from the comparison, such as the predicted number of frames until the focused defined object will have fewer pixels in an active area of display 14 relative to a second defined object. In one embodiment, the transition from the first defined object to the second defined object includes a gradually increasing blurriness added to the first defined object with a gradually decreasing blurriness added to the second defined object. In other alternative embodiments, degrees of blurriness may attach to defined objects with increased blurriness to each defined object as the defined object has a lower precedence relative to the active area and other defined objects. Essentially, the effect provided is an artificial increased focal length focused at a defined object selected by an end user relative to other defined objects.

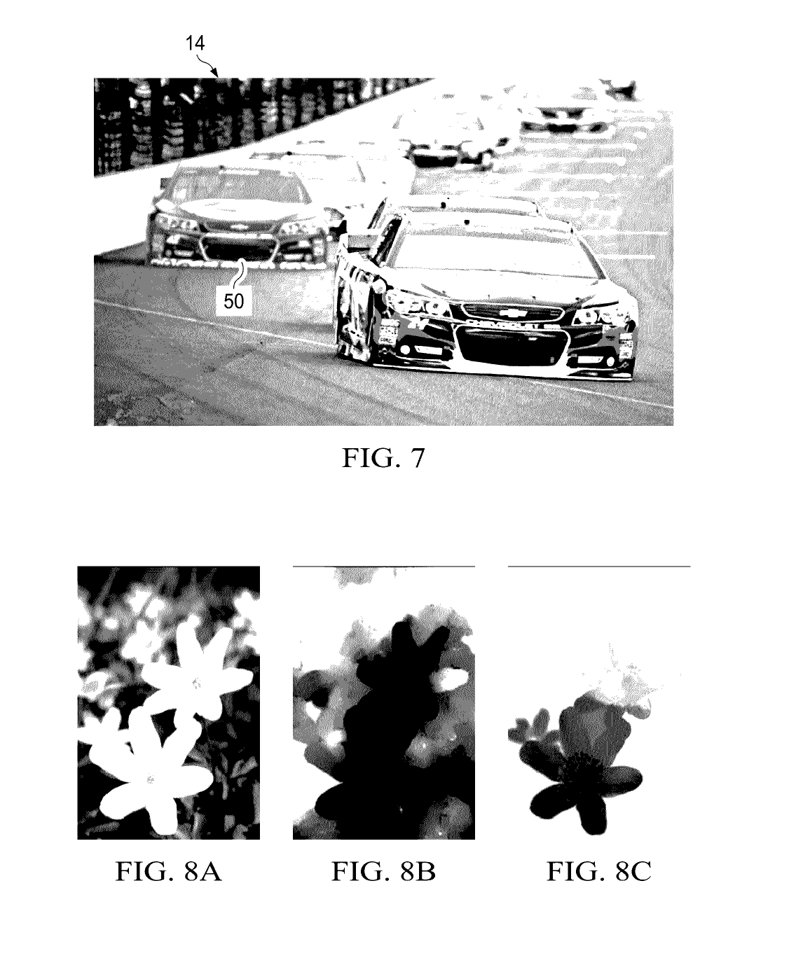

Referring now to FIGS. 7A and 7B, an example depicts a visual image having an area outside of a defined object adjusted to assume a black and white coloring. Focus mapper 32 identifies defined objects and focused image adjuster 34 applies a color adjustment in addition to or in the place of defocus adjustment. A color scheme self-aligns to defined elements through a sequence of video frames as the defined objects move through the video frames. Providing defocused portions of the image with no color or reduced color further highlights the portion of the screen of interest to the end user. FIGS. 8A, 8B and 8C depict a defined object with a focus map defined by image brightness. A flower image in an original image of FIG. 8A has two focus maps of FIGS. 8B and 8C with different light intensity adjustments applied. Since each defined object has its own adjustment to brightness, an end user has increased flexibility in how the end user presents the adjusted image by using different light intensity adjustments at different defined objects.

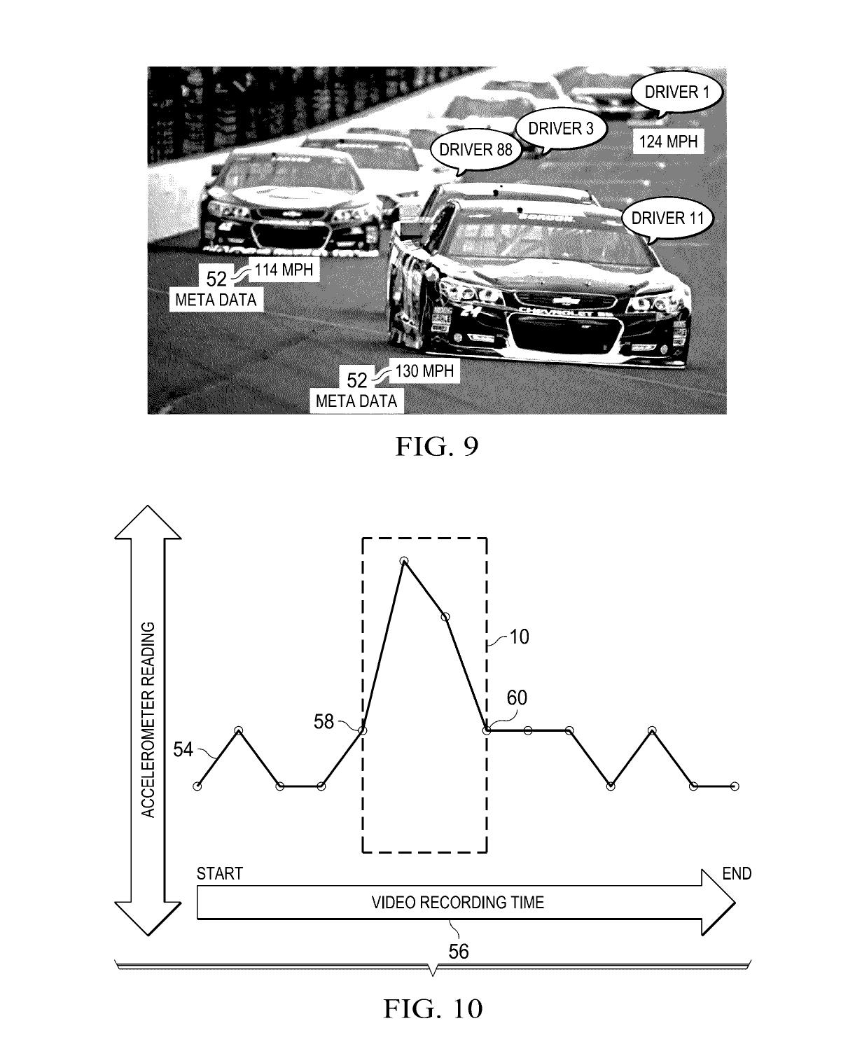

Referring now to FIG. 9, an example depicts a visual image having meta data associated with the defined objects. In the example embodiment, contextual data is added for each defined object so that the text is presented in boxes 52 as focus mapper 32 tracks the defined objects from video frame to video frame. The end user captures an image of an event and selects the defined objects to track as set forth above. The end user then adds contextual data in association with the defined objects such as in tabular format, video format, text format or other techniques, such as with a temporal definition that adds data based on visual information time stamps. In the example of FIG. 9, the textual data could include driver names, speeds or other information of interest. When used with real time video, the metadata can, for example, identify portions of interest in the video for the end user so that the end user can track points of interest more easily.

Referring now to FIG. 10, a block diagram depicts an acceleration based correction of a visual image. Acceleration adjuster 36 uses a combination of accelerations detected by accelerometers in the housing and tracking of defined objects to smooth visual images captured in real time by a camera. As is depicted by accelerometer reading 54, normal small movements are smoothed with conventional stabilization techniques, however, a large bump event 58 causes too large of a deviation in a captured video for stabilization to correct. Such large events tend to occur during a relatively short time period over a video recording time and end at point 68 with a relatively stabilize video capture. Acceleration adjuster 36 marks the video frame that first experiences the bump event 58 and end bump event 60 so that visual images between the bump events may be adjusted. The most basic adjustment is to drop the video frames captured during the bump events and fill in the dropped frames with the frame that precedes and follows the bump event as if a virtual pause took place in the video. Other types of post processing may be used based upon defined objects in the video frame. For example, the defined object is tracked along its predicted movement and placed in the position of the predicted movement during the bump event while the remainder of the background is defocused so that the video element of interest to the end user is tracked as fully as possible. Other types of post processing that includes a bump event and defined object tracking may include a graying of the background or change of background brightness to best highlight the captured defined object(s).

Although the present invention has been described in detail, it should be understood that various changes, substitutions and alterations can be made hereto without departing from the spirit and scope of the invention as defined by the appended claims.

What is claimed is:

1. A portable information handling system comprising:
a planar housing;
a processor disposed in the planar housing and operable to execute instructions to process information;
a memory disposed in the planar housing and interfaced with the processor, the memory operable to store the information;
a graphics processor interfaced with the processor and operable process information into pixel values for presentation of the information at display pixels as a visual image;
a display disposed at one side of the planar housing and interfaced with the graphics processor and memory, the display operable to present the information as the visual image;
a focus mapper interfaced with the graphics processor and operable to detect plural defined objects in the visual image based on image blur at object edges; and
a focused image adjuster interfaced with the graphics processor and operable to defocus the visual image outside one or more selected of the plural defined objects.

2. The portable information handling system of claim 1 further comprising a camera, the camera providing the visual image to the graphics processor, the focus mapper detecting the plural defined objects from the camera visual image, the focused image adjuster adjusting the visual image to save in the memory.

3. The portable information handling system of claim 2 wherein the visual image comprises a video received in real time from the camera, the focus mapper tracking the one or more selected of the plural defined objects in each of plural video frames captured by the camera.

4. The portable information handling system of claim 1 wherein the focused image adjuster is further operable to apply a color adjustment for the visual image portion that is defocused.

5. The portable information handling system of claim 1 wherein the focused image adjuster is further operable to associate a metadata with the one or more of selected of the plural defined objects.

6. The portable information handling system of claim 5 wherein the visual image comprises a video having plural frames, and the focus mapper is further operable to track the one or more selected of the plural defined objects in each of the plural video frames and insert the metadata in the image proximate the one or more of the plural defined objects.

7. The portable information handling system of claim 6 wherein the video comprises a video captured in real time by a camera.

8. The portable information handling system of claim 1 further comprising a selection page presented at the display by the focus mapper, the selection page having the plural defined objects highlighted to allow an end user to select defined objects at the display.

9. A method for presenting a visual image at a portable information handling system, the method comprising:
presenting the visual image at a display of the portable information handling system;
detecting one or more defined objects in the visual image by detecting image blur at an edge of each of the one or more defined objects;
presenting the one or more defined objects identified as such at the display;
accepting a selection of one or more of the defined objects by an end user; and
in response to the selection, defocusing the visual image outside of the one or more defined objects.

10. The method of claim 9 further comprising:
capturing the visual image with a camera and presenting the visual image in real time at the display; and
automatically tracking the selected one or more defined objects by reference to the image blur as the selected one or more defined objects move in the visual image.

11. The method of claim 10 further comprising:
associating a meta data with the selected one or more defined objects; and
presenting the meta data at the display proximate the selected one or more defined objects as the selected one or more defined objects move in the visual image.

12. The method of claim 10 further comprising:
defining an active area in a central portion of the display; and
defocusing selected one or more defined objects that move out of the active area.

13. The method of claim 9 further comprising applying a color adjustment to the defocused portion of the visual image.

14. The method of claim 13 wherein the color adjustment comprises presentation of the visual image as black and white in the defocused portion.

15. The method of claim 9 further comprising:
detecting an acceleration of greater than a predetermined amount at the portable information handling system;
storing the visual image in a storage device as a video having plural frames over a time period that includes the acceleration; and
removing from the storage device one or more of the frames associated with the time period of the acceleration.

16. The method of claim 9 wherein the visual image comprises a video having plural frames stored in a storage device and retrieved for post-processing.

17. A system for managing presentation of a visual image at a portable information handling system, the system comprising:
non-transitory memory storing instructions operable to:
present the visual image at a display of the portable information handling system;
detect one or more defined objects in the visual image by detecting image blur at an edge of each of the one or more defined objects;
present the one or more defined objects identified as such at the display;
accept a selection of one or more of the defined objects by an end user; and
in response to the selection, defocus the visual image outside of the one or more defined objects.

18. The system of claim 17 wherein the non-transitory memory instructions are further operable to:
capture the visual image with a camera and present the visual image in real time at the display; and
automatically track the selected one or more defined objects by reference to the image blur as the selected one or more defined objects move in the visual image.

19. The system power system of claim 17 wherein the non-transitory memory instructions are further operable to:
detect an acceleration of greater than a predetermined amount at the portable information handling system;
store the visual image in a storage device as a video having plural frames over a time period that includes the acceleration; and
remove from the storage device one or more of the frames associated with the time period of the acceleration.

20. The system power system of claim 17 wherein the non-transitory memory instructions are further operable to apply a color adjustment to the defocused portion of the visual image.
